(19) United States
(12) Patent Application Publication
(10) Pub. No.: US 2014/0351323 A1
(43) Pub. Date: Nov. 27, 2014

(54) SAFETY EVALUATION METHOD AND SAFETY EVALUATION COMPUTER

(71) Applicants: Tomoyo Sumida, Tokyo (JP); Yuichiro Hirata, Tokyo (JP)

(72) Inventors: Tomoyo Sumida, Tokyo (JP); Yuichiro Hirata, Tokyo (JP)

(73) Assignee: HITACHI, LTD., Tokyo (JP)

(21) Appl. No.: 14/356,101

(22) PCT Filed: Nov. 2, 2011
(86) PCT No.: PCT/JP2011/075351

§ 371 Date: May 2, 2014

(51) Int. Cl. H04L 29/08; H04L 29/06

(52) U.S. Cl. CPC H04L 67/36; H04L 67/42
USPC 709/203

(57) ABSTRACT

A safety evaluation computer evaluates safety of user data which is data of a client computer and relating to storage into a server computer based on a server area ID which is an area ID of an area where the server computer is located, and displays a result of evaluation of the safety.

### TECHNICAL FIELD

The present invention relates to a technique for evaluating safety in storing data in a data center in environments that provide users with cloud-computing (cloud) based services.

### BACKGROUND ART

Various cloud-computing based services are known; for example, a method of dividing a computing service into individual jobs in such a way as that the jobs satisfy statutory audit requirements, and presenting a user with a distributed execution plan for each job (for example, see PTL 1) is known.

### CITATION LIST

### Patent Literature

[PTL1] Japanese Patent Application Laid-open No. 2011-96115

### SUMMARY OF INVENTION

### Technical Problem

The above method takes into account only audit requirements and execution requirements on execution of a service, and does not consider audit requirements on the owner of data and the location at which the processing is executed.

At the time of using public cloud services, for example, it is necessary to select a data center to store data in consideration of the following regulations (laws, rules). It should be noted that data includes data, such as a document, a program (including the source format, the execution format), a table and an image.

In other words, a data center needs to be selected in consideration of the regulations of a country where a user who deposits data is located, the regulations of a country where a data center is located, and the regulations of a country where a cloud service provider is located.

When a user who deposits data is located in Japan, for example, the in order to be export, deposit of data in a data center in a foreign country foreign is regarded as exporting, so that as the regulations of a country where a user who deposits data is located, the Foreign Exchange Law and the Foreign Trade Law (Foreign Exchange Control Law) need to be checked.

With regard a country where a data center is located, and a country where a cloud service provider is located, the data deposition is regarded as importing of data, so that as the regulations of the country where the data center is located, and the regulations of the country where the cloud service provider is located include regulations on import control, obligation to disclose data when in case of emergency, and the like.

For cloud services, ensuring safety based on the domestic and foreign regulations are entrusted to the discretion of the users of cloud services. In other words, it is not possible to make cloud users aware of crisis against legal risks.

### Solution to Problem

Safety evaluation is performed by a computer system including a client computer, a safety evaluation computer, and a server computer. Based on a server area ID that is the area ID of a local area where the server computer is located, safety of user data or data in the client computer in connection to storage into the server computer is evaluated, and the results of the evaluation of safety are displayed.

### BRIEF DESCRIPTION OF DRAWINGS

FIG. 1 is a diagram illustrating a configurational example of a computer system according to an embodiment.

FIG. 2 is a diagram illustrating a configurational example of a client computer according to the embodiment.

FIG. 3 is a diagram illustrating a configurational example of a server computer according to the embodiment.

FIG. 4 is a diagram illustrating a configurational example of a safety evaluation machine according to the embodiment.

FIG. 5 is a diagram illustrating an example of the functions of the safety evaluation program according to the embodiment.

FIG. 6 is a diagram illustrating an example of a file list table according to the embodiment.

FIG. 7 is a diagram illustrating an example of a user information table according to the embodiment.

FIG. 8 is a diagram illustrating an example of a DC information table according to the embodiment.

FIG. 9 is a diagram illustrating an example of an export control information table according to the embodiment.

FIG. 10 is a diagram illustrating an example of acceptance criterion information table according to the embodiment.

FIG. 11 is a diagram illustrating an example of an export/import related regulation table according to the embodiment.

FIG. 12 is a diagram illustrating an example of a first regulation determination rule table according to the exemplary embodiment.

FIG. 13 is a diagram illustrating an example of a second regulation determination rule table according to the embodiment.

FIG. 14 is a diagram illustrating an example of a data disclosure/seizure regulation table according to the embodiment.

FIG. 15 is a diagram illustrating an example of the data disclosure/seizure risk table according to the embodiment.

FIG. 16 is a diagram illustrating an example of an evaluation result table according to the embodiment.

FIG. 17 illustrates an example of a flowchart of a DC information registration process according to the embodiment.

FIG. 18 illustrates an example of a DC information registration screen according to the embodiment.

FIG. 19 illustrates an example of a flowchart of a regulation information registration process according to the embodiment.

FIG. 20 illustrates an example of a flowchart of a process upon data uploading according to the embodiment.

FIG. 21 illustrates an example of an upload screen according to the embodiment.

FIG. 22 illustrates a first example of an evaluation result screen according to the embodiment.

FIG. 23 is a second example of the evaluation result screen according to the embodiment.

FIG. 24 illustrates an example of a flowchart of a data attribute registration process according to the embodiment.

FIG. 25 illustrates an example of a data attribute setting screen according to the embodiment.

FIG. 26 illustrates an example of a flowchart of a safety evaluation registration process according to the embodiment.

FIG. 27 illustrates an example of a flowchart of a safety evaluation process on export and import management according to the exemplary embodiment.

FIG. 28 illustrates an example of a flowchart of a safety evaluation process on data disclosure/seizure according to the embodiment.

FIG. 29 illustrates an example of a flowchart of a data attribute addition/update process according to the embodiment.

FIG. 30 illustrates an example of a flowchart of the safety re-evaluation process according to the embodiment.

FIG. 31 illustrates an example of a flowchart of safety satisfying DC search process according to the embodiment.

FIG. 32 illustrates an example of a DC candidate display screen according to the embodiment.

### DESCRIPTION OF EMBODIMENTS

An embodiment is described with reference to the drawings. The embodiment described below does not limit the invention set forth in the claims, and not all of various components and combinations thereof described in the description of the embodiment are necessarily mandatory in the solution of the invention.

While there are cases in the following description where information in the invention is described with expressions such as “aaa table,” “aaa list,” “aaaDB,” “aaa queue” and “aaa Table,” the information may be expressed without a data structure represented by data structures other than table, list, DB, queue, Table and the like. To show non-dependency upon a data structure, “aaa information” “aaa table”, “aaa list”, “aaaDB”, “aaa queue,” “aaa Table” and the like may be referred to as “aaa information.” Further, the expressions “identification information,” “identifier,” “name,” and “ID,” which are used in describing the contents of each information, are substitutable with one another.

Although a program or a module in a program may be used as the subject of a sentence in describing a process in the following description, a program (module in a program), when executed by a processor (e.g., CPU (Central Processing Unit)) included in a control device, performs a prescribed process using a storage source (e.g., memory) and/or a communication interface and device (e.g., port) as needed, so that the subject of a sentence for a process may be a processor. A process described with a program or a module in a program used as the subject of a sentence may be a process that is performed by a processor or a computer including the processor. In addition, a hardware circuit that performs a part of or all of a process to be performed by a processor may be included. A program may be installed from a program source. The program source may be, for example, a program distributing server or a storage medium. The control device may include a dedicated hardware circuit that performs a predetermined process (e.g., encryption, decompression or the like), so that the process may be performed using the processor and the dedicated hardware circuit.

A safety evaluation machine according to the embodiment includes an input/output device. Examples of the input/output device include a display, a keyboard and a pointer device, but other devices may be used as the input/output device. Further, the input/output device may be replaced with a serial interface or an Ethernet (Trademark) interface may be connected to a display apparatus having a display, a keyboard or a pointer device to transmit display information to the display apparatus or receive input information therefrom so as to display information on the display apparatus and receive inputs therefrom as an alternative to the input/output device.

A safety evaluation apparatus may be a set of one or more computers. When a computer displays display information, this computer is the safety evaluation apparatus. In addition, the combination of a display apparatus and a computer is also a safety evaluation apparatus. In addition, a plurality of computers may achieve processing equivalent to the processing of a safety evaluation machine to increase the speed and reliability of a management process. In this case, a plurality of computers serve as a safety evaluation apparatus (display apparatus included when the display device performs display). In this embodiment, each computer that performs the safety evaluation is referred to as “safety evaluation machine.” The safety evaluation machine may be an apparatus that achieves a virtual machine (what is called, for example, virtual desktop).

In addition, in the embodiment, an act of the safety evaluation machine to “display” may be one of an act of displaying safety evaluation results or the like on the display device of the safety evaluation machine, and an act of transmitting display information to be displayed on the display device of a display apparatus (e.g., client) of a safety evaluation machine to the display apparatus. When receiving display information, the display apparatus can display safety evaluation results or the like represented by the display information on the display device.

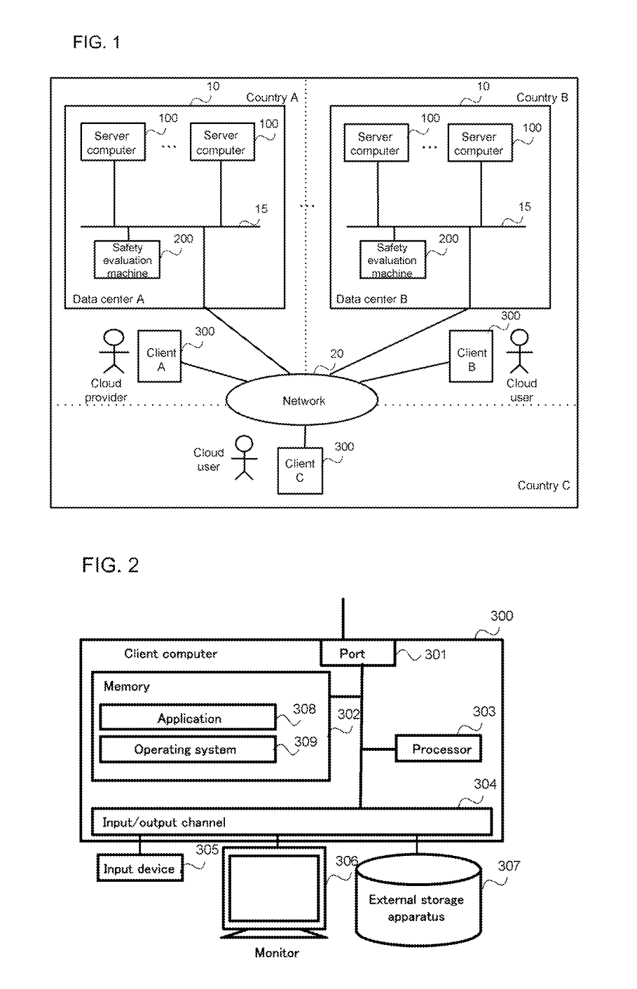

First, the outline of the embodiment is described referring to FIG. 1.

Regulation information in each country to which a data center 10 (server computer 100) and a 300 client belong is stored in advance in a storage device (not shown) that is used by a safety evaluation machine 200. The safety evaluation machine 200 receives attribute information for data (data attribute information). At the time of uploading data, changing the regulations, changing the data attribute information, or the like, the safety evaluation machine 200 evaluates safety of allocation of data to a data center 10 (server computer 100) based on an area ID of the area where the data center 10 (server computer 100) belongs, and, for example, displays the results of the evaluation on the client 300 for the user (i.e., transmits display information on the evaluation results to the client 300). The area ID may be anything, such as the name of a country or an address, which uniquely specifies an area (country, state, prefecture or the like) or a range that defines the regulations. Further, the top-level domain of the server computer 100 may be used as the area ID. However, in this case, it is necessary that the country indicated by the top-level domain, and the country of location of the server computer 100 actually are the same. Further, as a regional ID, for example, IP addresses may be used. Basically, the IP address of the corresponding country is high, when it can be used as an area ID. In this case, however, the country specified by the top-level domain should match the country where the server computer 100 is actually located. In addition, an IP address, for example, may be used as the area ID. Basically, the IP address has a high degree of association with a country, so that the IP address is often usable as the area ID.

Next, the embodiment is described in detail.

To begin with, the terms used herein are described.

“Safety” is a legal risk that takes into account, for example, regulations (laws and rules). The regulations to be considered include regulations of a country where a user of cloud-computing based services (cloud users) is located, and regulations of a country where a data center (DC) that manages data is located. According to the embodiment, security on export and import control, and security on data disclosure/seizure are subject to evaluation.

The “security on export and import control” is a legal risk that takes into account export regulations, re-export regulations, import regulations at the location of a DC. For example, regulations to be considered include Foreign Exchange Law and Foreign Trade Law in Japan, and EAR (Export Administration Regulations) in the United States of America.

The “security on data disclosure/seizure” is a risk of forced disclosure of data and seizure of data by public power at the location of a data center. With data stored in a data center, for example, when another user who is using the same data center has conducted a disgraceful affair which is investigated, the server at the data center is seized, disabling access to data, or confidential information in the server may be forcibly disclosed.

These risks vary according to the regulations of the government or the investigative authorities of each country, the risk of data disclosure/seizure is evaluated based on the regulations of each country. For example, regulations of interest include the Patriot Act in the U.S.A., which allows the FBI and the government authorities to have investigation power on data present in the United States, Regulation of Investigatory Powers Act in the United Kingdom, and Regulation of Data Control Investigatory Powers in China.

Next, a computer system according to the embodiment is described.

FIG. 1 is a diagram illustrating a configurational example of the computer system according to the embodiment.

The computer system includes a plurality of data centers (DCs) 10 and a plurality of client computers (hereinafter referred to as clients) 300. The plurality of data centers 10 and the plurality of clients 300 are connected to a network 20.

The data center 10 has at least one server computer (hereinafter, referred to as server) 100, and a safety evaluation machine (safety evaluation computer) 200. The server 100 and the safety evaluation machine 200 are connected to the network 20 via over an internal network (e.g., LAN (Local Area Network)) 15. The data centers 10 include a data center A which is sited in a country A, and a data center B which is sited in a country B.

The server 100 provides cloud services such as a storage service, a platform renting service, and an application service. The safety evaluation machine 200 interrupts the process of uploading data (user data: data such as documents, programs, tables, images) of a user (cloud user) of cloud services data to the server 100, and manages the safety of the user data, and the server 100 to which the user data is uploaded.

The clients 300 include, for example, a client A that is sited in the country A and is used by the provider of cloud services (cloud provider), a client B that is sited in the country B and is used a cloud user, and a client C that is sited in the country C and is used a cloud user.

The cloud user can use the client 300 to utilize the services provided by the server 100 over the network 20. In the computer system, the data center 10 may be accessed by the client 300 of a cloud user in a country different from the country where the data center 10 is located.

FIG. 2 is a diagram illustrating a configurational example of a client 300.

The client 300 includes a port 301, a memory 302, a processor 303, and an input/output channel 304. The port 301 mediates communication with other apparatuses via the network 20. The I/O channel 304 is connected with an input device 305, a monitor 306, an external storage apparatus 307 and the like. The I/O channel 304 mediates communication among these apparatuses. The input device 305 is, for example, a keyboard, a mouse or the like, and receives inputs of various kinds of information made by the user. The monitor 306 displays an image output or the like. The external storage apparatus 307 is, for example, a storage apparatus such as HDD (Hard Disk Drive) to store data or the like used by the client 300.

The memory 302 stores a computer program that is executed by the processor 303, and data that is used by the processor 303. The memory 302 stores, for example, an operating system 309, and an application 308. The processor 303 executes various processes according to the program stored in the memory 302.

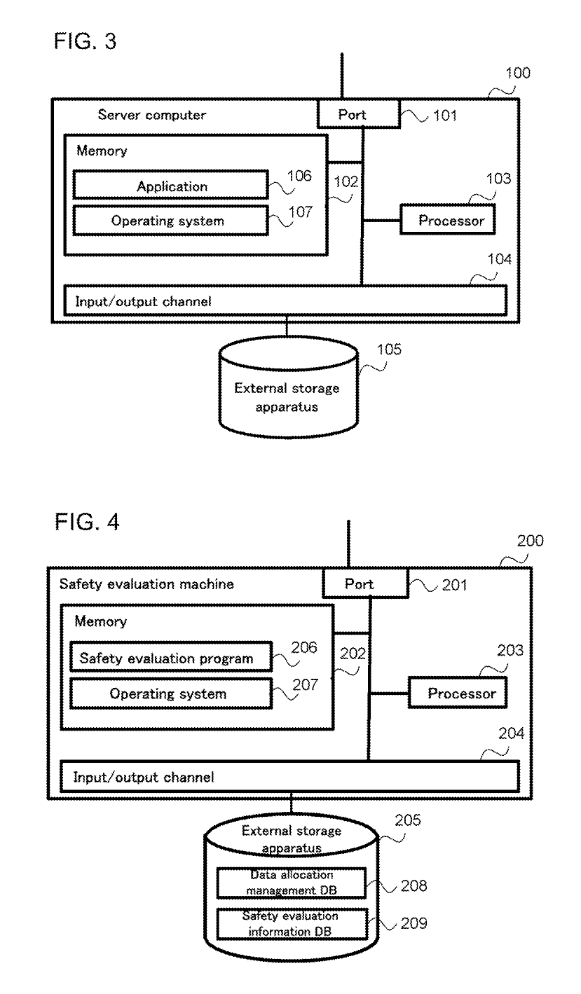

FIG. 3 is a diagram illustrating a configurational example of the server 100.

The server 100 includes a port 101, a memory 102, a processor 103, and an input/output channel 104. The port 101, mediates communication with other devices via the network 20 and the internal network 15. The I/O channel 104, an external storage apparatus 105 is connected. The I/O channel 104 mediates communication between the external storage apparatus 105. For example, a storage device such as HDD, an external storage apparatus 105 stores the user data and the like are uploaded from the client computer 300. Further, the server 100 may be incorporated in the storage device in place of the external storage apparatus 105.

The memory 102 stores programs used by the processor 103, the data used by the processor 103. For example, the memory 102 stores an operating system 107, and an application 106. The processor 103 executes various processes according to the program stored in the memory 102.

FIG. 4 is a diagram illustrating a configurational example of the safety evaluation machine 200.

The safety evaluation machine 200 includes a port 201, a memory 202, a processor 203, and an input/output channel 204. The port 201 mediates communication with other apparatuses over the internal network 15 and the network 20. The I/O channel 204 is connected with the external storage apparatus 205. The I/O channel 204 mediates communication with the external storage apparatus 205. For example, the external storage apparatus 205 is a storage apparatus, such as an HDD, to store data or the like that is used by the safety evaluation machine 200. In the embodiment, the external storage apparatus 205 stores a data allocation management database (data allocation management DB) 208, and a safety evaluation information database (safety evaluation information DB) 209. The safety evaluation machine 200 may incorporate a storage apparatus in place of the external storage apparatus 205.

The memory 202 stores a program that is used by the processor 203, and data that is used by the processor 203. The memory 202 stores, for example, an operating system 207 and a safety evaluation program 206 that executes processing related to safety evaluation. The processor 203 executes various processes according to a program stored in the memory 202.

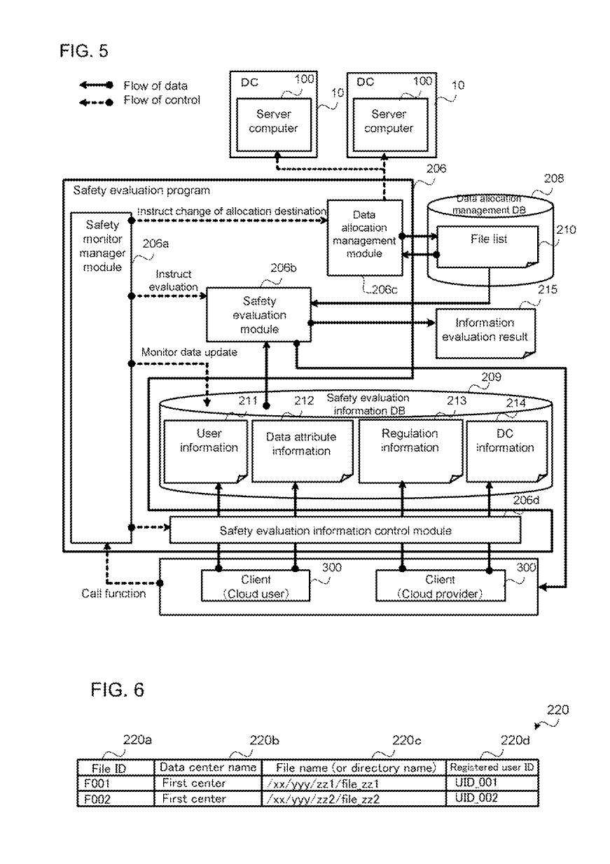

FIG. 5 is a diagram illustrating an example of the functions of the safety evaluation program 206.

The safety evaluation program 206 includes a plurality of program modules, such as a safety monitor manager module 206a, a safety evaluation module 206b, a data allocation management module 206c, and a safety evaluation information control module 206d. The safety evaluation program 206 performs various processes using information such as the data allocation management DB 208 and the safety evaluation information DB 209, which are stored in the external storage apparatus 205, and evaluation result information 215.

The safety monitor manager module 206a receives a request for evaluating safety of user data, and a request for changing data attribute information. Further, the safety monitor manager module 206a gives an instruction to reallocate data (data reallocation instruction) according to the results of evaluating safety.

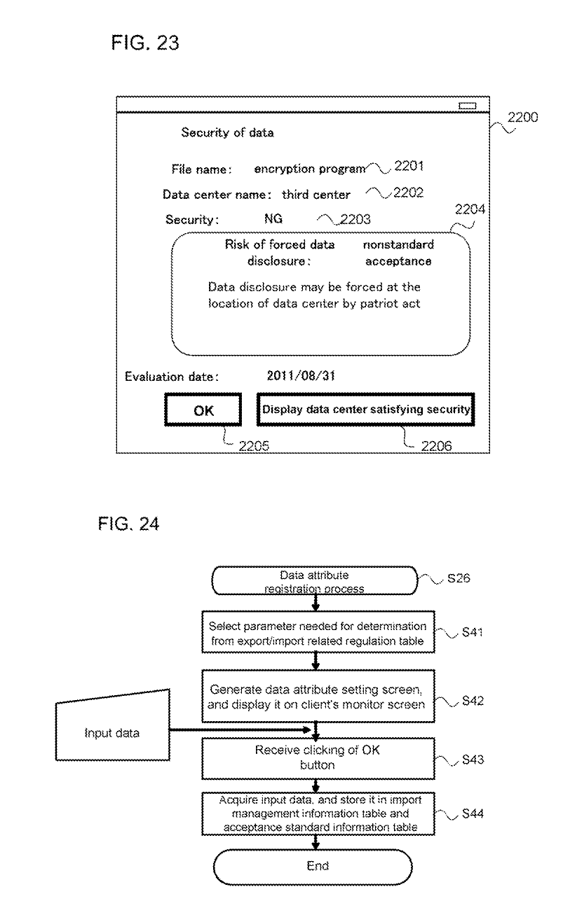

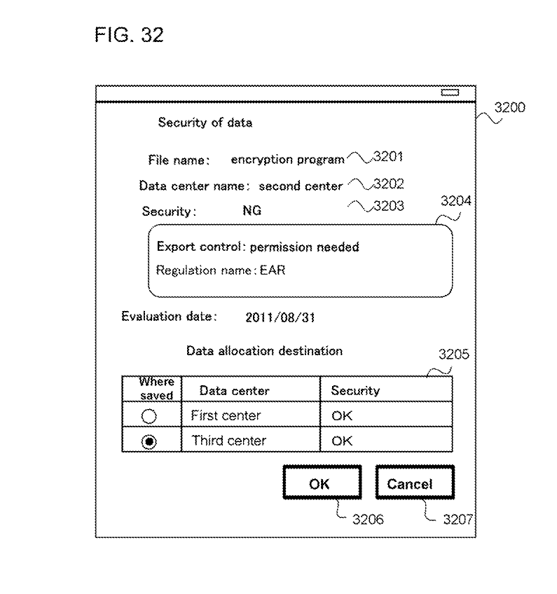

The safety evaluation module 206b evaluates safety on the allocation of user data. The safety evaluation module 206b stores the results of evaluation on safety in the memory 202 or the external storage apparatus 205 as evaluation result information 215. In addition, the safety evaluation module 206b displays screens (evaluation result screen (see FIGS. 22 and 23), DC candidate display screen (see FIG. 32)) on the client 300.

The data allocation management module 206c executes a process for managing the location of user data. When receiving the data reallocation instruction from the safety monitor manager module 206a, for example, the data allocation management module 206c migrate the corresponding user data to update information on the file list 210.

The safety evaluation information control module 206d receives an input made by the user (cloud provider or cloud user) from the client 300, and registers and updates information in the safety evaluation information DB 209.

The data allocation management DB 208 stores the file list 210 for managing in which DC 10 data uploaded by the user (user data) is stored. The safety evaluation information DB 209 stores various kinds of information used in evaluation of safety (user information 211, data attribute information 212, regulation information 213, DC information 214). According to the embodiment, the user information 211 and the data attribute information 212 are defined by the cloud user. In addition, the regulation information 213 and the DC information 214 are defined by the cloud provider.

As an example of the file list 210, a file list table 220 is used in the embodiment.

FIG. 6 is a diagram illustrating an example of the file list table 220.

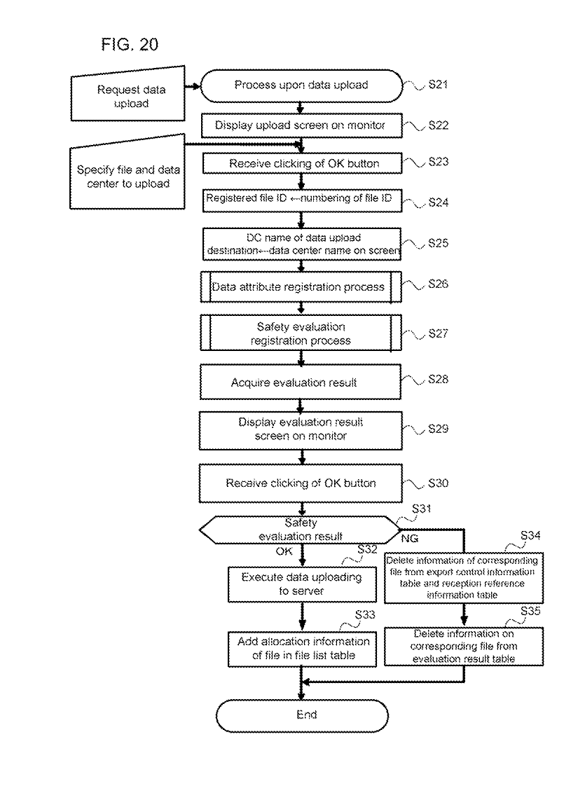

The file list table 220 manages which file (file of user data) is uploaded to the server 100 of which DC 10. The file list table 220 includes fields of a file ID 220a, a data center name 220b, a file name (or directory name) 220c, and a registered user ID 220d. All the fields of data are stored in this file list table 220 as a process upon data upload (see FIG. 20) is performed.

The file ID 220a stores an ID that uniquely identifies a file. The data center name 220b stores the name of a data center that stores the corresponding file. The file name (or directory name) 220c stores the file name or directory name of the corresponding file. The registered users ID 220d stores the user ID of the cloud user who has registered the corresponding file.

For example, the topmost record in the file list table 220 indicates that the file with the file ID of “F001” is stored in a first center, the file name is “/xx/yyy/zzl/file_zzl” and the user ID of the user who has registered the file is “UID_{—}001.”

As an example of the user information 211, a user information table 221 is used in the embodiment.

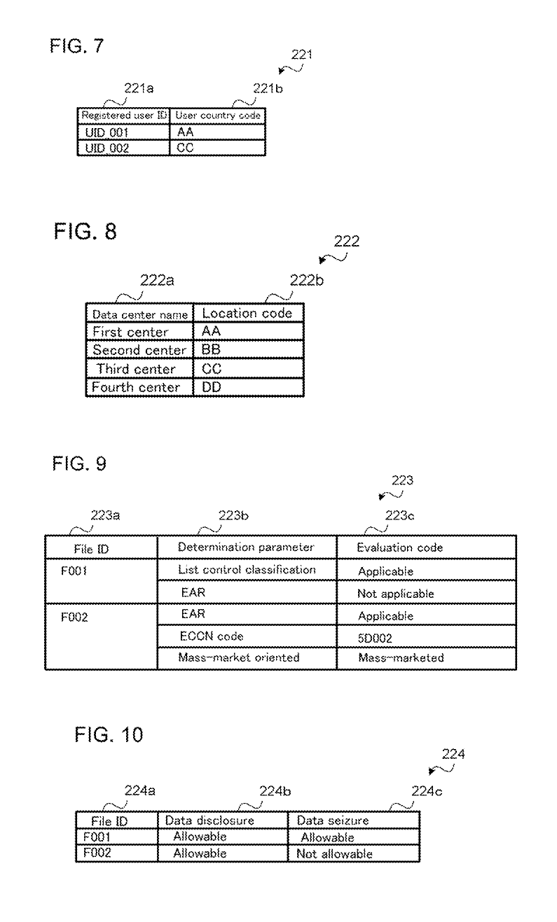

FIG. 7 is a diagram illustrating an example of the user information table 221.

The user information table 221 includes fields of a registered user ID 221a and a user country code 221b. The registered users ID 221a stores the ID of the user. The user country code 221b stores the code of the country where the user resides (client area ID). The user information table 221 is generated based on the information registered by the user, for example, when the use of the computer system starts. For example, the topmost record in the user information table 221 shows that the user with the ID of “UID_{—}001” resides in the country with the country code of “AA.”

As an example of the DC information 214, a DC information table 222 is used in the embodiment.

FIG. 8 is a diagram illustrating an example of the DC information table 222.

The DC information table 222 includes fields of a data center name 222a and a location code 222b. The data center name 222a stores the name of the data center 10 (data center name). The location code 222b stores the code of the location (e.g., country) where the corresponding data center is located (location code: one example of the server area ID). The location of the data center 10 may also be the location of the server 100 belonging to the data center 10. The DC information table 222 is defined by a cloud provider, for example.

For example, the topmost record in the DC information table 222 shows that the “first center” is located in an area with the location code of “AA.”

As an example of the data attribute information 212, an export control information table 223 and acceptance criterion information table 224 are used in the embodiment.

FIG. 9 is a diagram illustrating an example of the export control information table 223.

The export control information table 223 includes fields of a file ID 223a, a determination parameter 223b, and an evaluation code 223c. The file ID 223a stores the file ID of the corresponding file. The determination parameter 223b stores at least parameter (determination parameter) that should be determined based on evaluation of safety against export control by the country (home country), restrictions where the cloud user owning the file resides, regulations by a first country different from the home country (re-export control (extraterritorial application of the first country) applied when a technology in the first country is exported to a third country from the home country, and import control by a country where the DC 10 is located. The evaluation code 223c stores a value or a code (evaluation code) corresponding to each determination parameter for the corresponding file.

For example, the topmost record in the export control information table 223 shows that the determination parameters for the file with the file ID of “F001” include a “list control classification” and “EAR,” and evaluation codes for the respective determining parameters are “applicable” and “not applicable.”

FIG. 10 is a diagram illustrating an example of the acceptance criterion information table 224.

The acceptance criterion information table 224 includes fields of a file ID 224a, and data disclosure 224b, a data seizure 224c. The file ID 224a stores the file ID of the corresponding file. The data disclosure 224b stores information indicating whether the cloud user can allow for the disclosure of the corresponding file. The data seizure 224c stores information indicating whether the cloud user can allow for the seizure of the corresponding file.

For example, the topmost record in the acceptance criterion information table 224 shows that data disclosure of the file with the file ID of “F001” is “allowable” and data seizure of the file is “allowable.”

As one example of the regulation information 213, an export/import related regulation table 225, regulation determination rule tables 226 and 227, a data disclosure/seizure regulation table 228, and a data disclosure/seizure risk table 229.

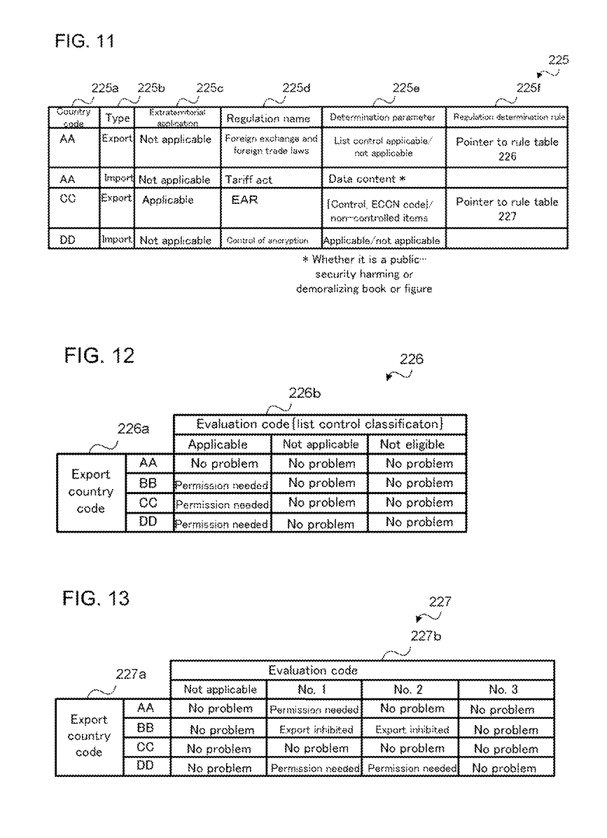

FIG. 11 is a diagram illustrating an example of the export/import related regulation table 225.

The export/import related regulation table 225 includes fields of a country code 225a, a type 225b, an extraterritorial application 225c, a regulation name 225d, a determination parameter 225e, and a regulation decision rule 225f. The country code 225a stores the code of an area (country, state or the like) where corresponding regulations are provided. The type 225b stores the type of restriction associated with the corresponding regulations. In this embodiment, for example, export is stored for the regulations relating to export and import is stored for the regulations relating to import. The extraterritorial 225c stores information indicating whether the corresponding regulations are applied to an area other than this area. For example, when the regulations in the country which is the origin of the data is extraterritorially applied, not only the regulations in the country where the data is currently stored, but also the regulations in the country of origin of the data whose regulations are extraterritorially applied should be considered. The extraterritorial application 225c is used to detect such a case. The regulation name 225d stores the name of the corresponding regulations (regulation name). The determination parameter 225e stores a parameter needed to determine the legal safety (determination parameter). The regulation determination rule 225f stores reference information (pointer) for the regulation determination rule table (226, 227 or the like) defining rules for determining the legal safety.

For example, the topmost record in the export/import related regulation table 225 shows that the corresponding regulations are the regulations in the area with the area code of “AA,” are related to “export,” and are not extraterritorially applied, the regulation name is “Foreign Exchange and Foreign Trade Laws”, the determination parameter is a list control classification, and a pointer corresponding to the regulation determination rule table is stored.

FIG. 12 is a diagram illustrating an example of the first regulation determination rule table 226.

The regulation determination rule table 226 defines the rules for determining whether there is a problem of safety for the corresponding regulations; the ordinate shows a list of codes of candidate countries to which export is intended, i.e., codes of countries where the DCs 10 belong, and the abscissa shows a sequence of values (evaluation codes) of the determination parameters of the corresponding regulations. This table shows whether exporting is possible (no problem), or needs export permission (permission needed), or is inhibited when data corresponding to an evaluation code with the determination parameter of list control classification is exported from a certain country to an exporting country.

For exporting to an area with the country code of “AA,” the table shows that there is no problem, i.e., exporting is possible regardless of whether the list control classification is “applicable” or“not applicable.” For exporting to an area with the country code of “DD,” exporting needs permission when the list control classification is “applicable.”

FIG. 13 is a diagram illustrating an example of the second regulation determination rule table 227.

The regulation determination rule table 227 defines the rules for determining whether there is a problem of safety for the EAR regulations in an area with the country code of “CC.” For example, the pointer in the regulation determination rule 225f in the third record in the export/import related regulation table 225 is set to this regulation determination rule table 227. The ordinate shows a list of codes of candidate countries to which export is intended, i.e., codes of countries where the DCs 10 belong, and the abscissa shows a sequence of evaluation codes indicating that the EAR is not applicable and at least one ECCN (Export Control Classification Number) in the EAR. This table shows whether exporting is possible (no problem), or needs export permission (permission needed), or is inhibited when data not corresponding to the ECCN or corresponding to the ECCN is exported from an area with the country code of “CC” to an exporting country.

For exporting to an area with the country code of “BB,” for example, when the ECCN is “number 1,” the table shows that the export is prohibited by the EAR.

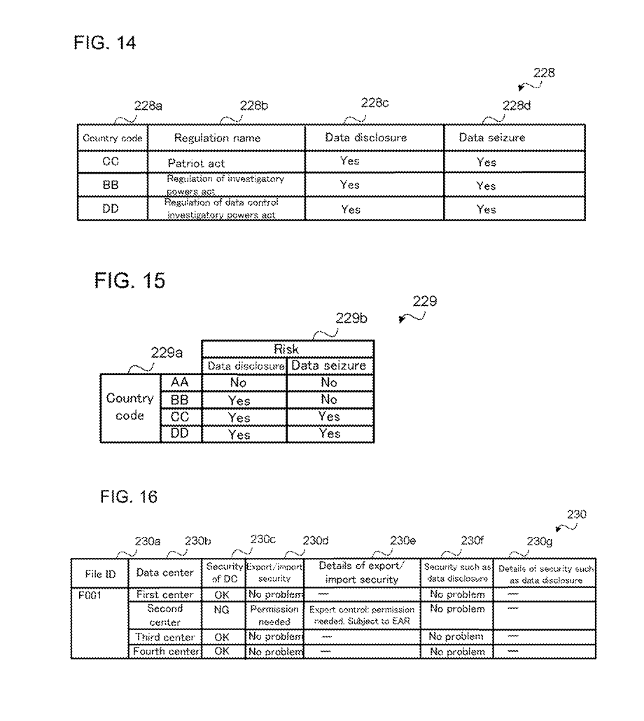

FIG. 14 is a diagram illustrating an example of the data disclosure/seizure regulation table according to the embodiment.

The data disclosure/seizure regulation table 228 includes fields of a country code 228a, regulation name 228b, and data disclosure 228c, and data seizure 228d. The country code 228a stores the code of an area (country, state or the like) where corresponding regulations are provided. The regulation name 228b stores the name of the corresponding regulations. The data disclosure 228c stores information for determining whether the corresponding regulations include any provision that allows the public power to enforce data disclosure in case where a predetermined event occurs. The data seizure 228d stores information for determining whether there is any provision that allows for seizure of data.

For example, the topmost record in the data disclosure/seizure regulation table 228 shows that the corresponding regulations are the regulations in an area with the area code of “CC,” the regulation name is “Patriot Act,” and the corresponding regulations include a provision that allows for disclosure of data, and a provision that allows for seizure of data.

Although the data disclosure/seizure regulation table 228 has been described as a table for managing legal risks for provisions for data disclosure and data seizure, a configuration similar to this table can deal with a case where considerations other than data disclosure and data seizure need to be made.

FIG. 15 is a diagram illustrating an example of the data disclosure/seizure regulation table 228 according to the embodiment.

This data disclosure/seizure risk table 229 defines whether there is a risk for data disclosure or data seizure in each country, and can be obtained by organizing the individual records in the data disclosure/seizure regulation table 228 for each country. Although the presence of the data disclosure/seizure risk table 229 makes the data disclosure/seizure regulation table 228 unnecessary, the data disclosure/seizure regulation table 228 is held to display the regulation name in the embodiment.

The data disclosure/seizure risk table 229 has a list of codes of candidate countries as exporting countries, i.e., the codes of countries to which DCs belong aligned on the ordinate, and has fields of data disclosure and data seizure for determining risks aligned on the abscissa. The data disclosure/seizure risk table 229 defines presence/absence of risks of data disclosure and data seizure in each country.

The data disclosure/seizure risk table 229 shows that in the area with the country code of “BB,”, for example, there is a risk of data disclosure, but there is no risk of data seizure.

An evaluation result table 230 is used as an example of the evaluation result information 215 in the embodiment.

FIG. 16 is a diagram illustrating an example of the evaluation result table 230.

The evaluation result table 230 includes fields of a file ID 230a, a data center 230b, a DC security 230c, an export/import security 230d, details 230e of export/import security, a security 230f of data disclosure or the like, and details 230g of security of data disclosure or the like. The ID 230a file stores the file ID of the corresponding file. The data center 230b stores the name of a data center. The DC security 230c stores the result of determination of security (no problem (OK) or problem present (NG)) when the corresponding file is stored in the DC with the corresponding data center name. The export/import security 230d stores the result of determination of security of export/import. The details 230e of export/import security stores the details of the result of determination of security of export/import. The security 230f of data disclosure or the like stores the result of determination of security of data disclosure/seizure. The details 230g of security of data disclosure or the like stores the details of the result of determination of security of data disclosure/seizure.

For example, the second record in the evaluation result table 230 shows that when the file with the file ID of “F001” is stored in the second center, the security is NG (problem present), security of export/import is “permission needed,” i.e., permission is needed, the details of security of export/import is permission needed for export control and are subject to the EAR control, and security of data disclosure or the like has no problem.

Next, the processing and operation of the computer system according to the embodiment are described.

First, a DC information registration process is described. The DC information registration process is executed before the safety evaluation machine 200 starts controlling safety of user data to be uploaded to the cloud service, i.e., before the process upon data upload (FIG. 20) to be described later starts.

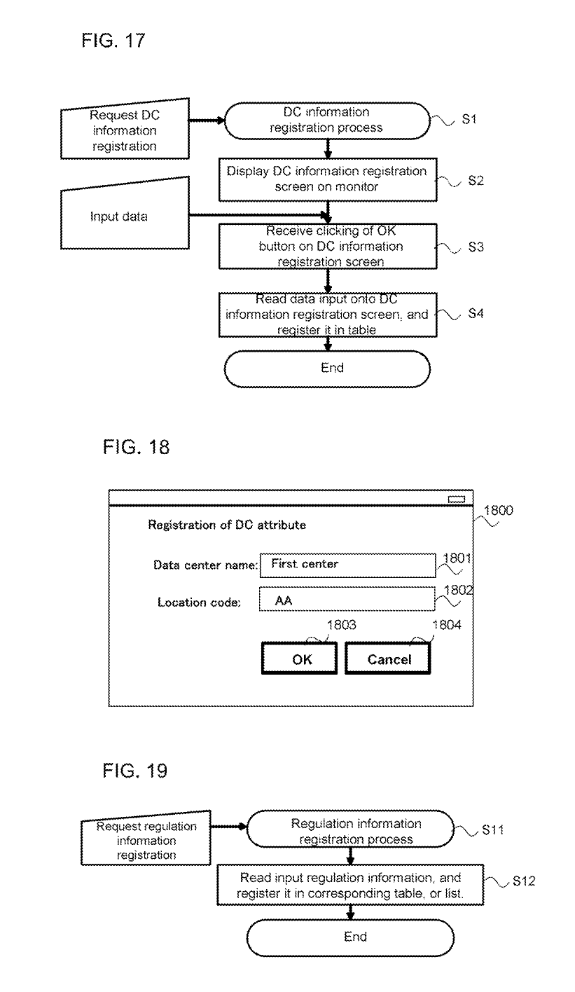

FIG. 17 is an example of a flowchart of the DC information registration process according to the embodiment.

When the safety monitor manager module 206a receives a DC information registration request from the client 300 of the cloud provider, the safety monitor manager module 206a instructs the safety evaluation information control module 206d to start the DC information registration process, and the safety evaluation information control module 206d starts the DC information registration process (step S1).

First, the safety evaluation information control module 206d displays a DC information registration process screen 1800 (FIG. 18) on the monitor 306 of the client 300 of the cloud provider (step S2). Specifically, the safety evaluation information control module 206d transmits data for displaying the DC information registration screen 1800 to the application 308 of the client 300 so that the application displays the DC information registration process screen 1800 on the monitor 306 of the client 300. Because the same is true of other screens to be displayed on the monitor 306 of the client 300, the specific process for displaying a screen is omitted hereinafter.

FIG. 18 is an example of the DC information registration screen according to the embodiment.

The DC information registration screen 1800 displays a data center name area 1801 for inputting the name of a data center that registers information, a location code area 1802 for inputting a location code (country code) indicating the location of the data center, an OK button 1803 for registering input contents, and a cancellation (Cancel) button 1804 for cancelling (stopping) registration of information. Although a country code is input in the DC information registration screen 1800, the correspondence between country and country code may be stored as an internal table, so that a user is permitted to select or input a country name on the screen to convert the country name into a country code based on the internal table.

Referring back to FIG. 17, the application 308 in the client 300 receives the data center name and the location code input by the input device 305 of the cloud provider for the DC information registration screen 1800, and when the OK button 1803 is pressed (e.g., clicked), information indicating the depression of the OK button 1803 and the input data are transmitted to the safety evaluation machine 200. When receiving clicking of the OK button 1803 on the DC information registration screen 1800 from the client 300 (step S3), the safety evaluation information control module 206d reads the input data, and registers an entry (record) of the data center name and the location code with the data center name in the input data being a key (step S4). When an entry of the corresponding data center name is already present in the DC information table 222, the location code in the entry is updated with the input location code. It should be noted that the cloud providers registers each data center in the computer system through the DC information registration process. Accordingly, the DC information table 222 having records corresponding to a plurality of DCs as shown in FIG. 8 is created.

Next, the regulation information registration process is described. The regulation information registration process is executed before the safety evaluation machine 200 starts the management of safety of user data to be uploaded to the cloud service. Further, the regulation information registration process is executed when revision of the regulations after starting operation of the service requires alteration of the registered regulation information.

FIG. 19 is an example of a flowchart of the regulation information registration process according to the embodiment.

When receiving the regulation information registration request from the client 300 of the cloud provider, the safety monitor manager module 206a instructs the safety evaluation information control module 206d to start the regulation information registration process, so that the safety evaluation information control module 206d starts the regulation information registration process (step S11). In the regulation information registration process, as in the DC information registration process, the client 300 is caused to display a screen for inputting necessary information in a table and a Table on the client 300, the cloud provider is caused to input necessary information, and the safety evaluation information control module 206d reads the information input from the client 300, and registers the input information in the corresponding table (step S12). According to the embodiment, in the regulation information registration processing, data needed for the data disclosure/seizure regulation table 228 and the data disclosure/seizure risk table 229, such as the export/import related regulation table 225, and the regulation determination rule tables 226, 227, is received, and the data is registered in these tables.

The following describes the process upon data upload that is executed when the user uploads user data stored in the client 300 to the server 100 of the DC 10.

FIG. 20 is an example of a flowchart of the process upon data upload according to the embodiment.

Before this process upon data upload is performed, the cloud user has already logged in the safety evaluation machine 200 to use the computer system using the client 300, so that the safety evaluation machine 200 can grasp the user ID of the cloud user.

When receiving the data upload request from the client 300 of cloud user, the safety monitor manager module 206a instructs the safety evaluation information control module 206d to start the process upon data upload, and the safety evaluation information control module 206d starts the process upon data upload (step S21).

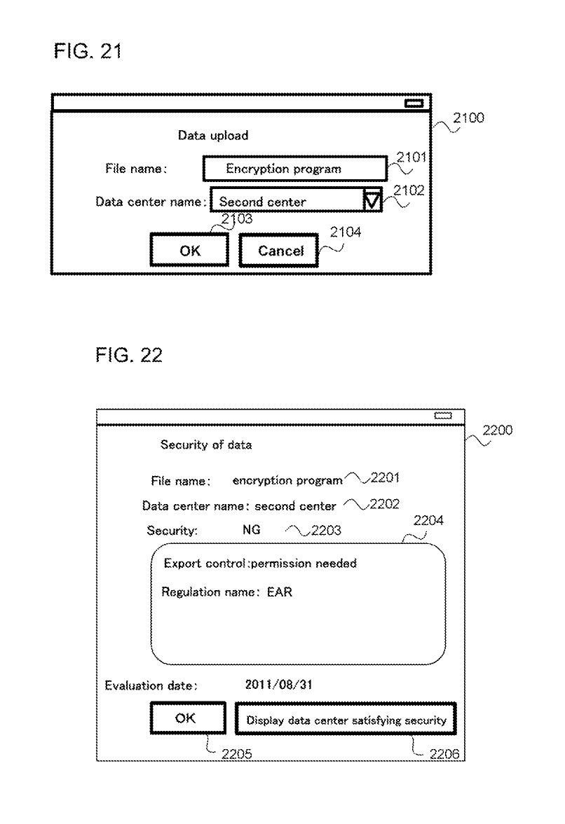

First, the safety evaluation information control module 206d displays an upload screen 2100 (FIG. 21) on the monitor 306 of the client 300 of the cloud user (step S22).

FIG. 21 is an example of the upload screen according to the embodiment.

A file name input area 2101 for inputting the name of a file to be uploaded, a data center selection area 2102 for selectively input a data center where data is to be uploaded, an OK button for deciding designation of the file name and the data center 10, and a cancellation button 2104 for cancelling designation of the file name and the data center 10 are displayed on the upload screen 2100.

Referring back to FIG. 20, in the client 300, the application 308 receives inputs of the name of the file to be uploaded by the input device 305 of the cloud user and the name of the upload destination data center for the upload screen 2100. When the OK button 2103 is clicked, information indicating the clicking of the OK button 2103, and the input file name and data center name are transmitted to the safety evaluation machine 200.

When the safety evaluation information control module 206d receives clicking of the OK button 2103 on the upload screen 2100 from the client 300 (step S23), the data allocation management module 206c numbers a unique file ID within the file list table 220, and sets this file ID as a registered file ID (step S24). It should be noted that when an attempt to register a file with the same name as the name of a file already registered in the same directory (in case of overwriting data), the corresponding file ID is acquired from the file list table 220.

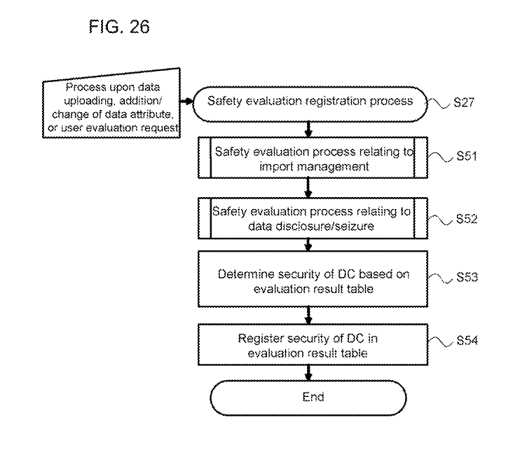

Then, the safety evaluation information control module 206d sets the data center name transmitted from the client 300 as the name of the data upload destination DC (step S25), and executes a data attribute registration process (FIG. 24) for registering the attribute of data in the file (step S26) with the registered file ID, file name and the name of the upload destination DC as arguments. Then, the safety evaluation module 206b executes the safety evaluation registration process (see FIG. 26) with the registered file ID and the name of the upload destination DC as arguments (step S27).

Next, the safety evaluation module 206b obtains the evaluation results needed for display from the evaluation result table 230 (step S28), and displays an evaluation result screen 2200 (e.g., FIGS. 22 and 23) on the monitor 306 of the client 300 of cloud user (step S29).

FIG. 22 illustrates a first example of the evaluation result screen according to the embodiment. FIG. 23 is illustrates a second example of the evaluation result screen according to the embodiment.

As shown in FIG. 22, a file name display area 2201 that displays the file name of the target of safety evaluation, a data center name display area 2202 for displaying the name of the upload destination data center, an evaluation result display area 2203 that displays the results of evaluation of safety, a detailed display area 2204 that displays the details of the evaluation results, an OK button 2205 for instructing confirmation of the evaluation of safety, and a display button 2206 that displays a data center satisfying safety are displayed on the evaluation result screen 2200.

OK is displayed in the evaluation result display area 2203 in case of no problem, and NG is displayed therein when there is a problem. When there is a problem with the export/import control, detailed information on export/import control and a regulation name relating to export/import control are displayed in detailed display area 2204 as shown in FIG. 22. When there is a legal risk about data disclosure, on the other hand, detailed information of a legal risk about data disclosure is displayed in detailed display area 2204 as shown in FIG. 23.

Referring back to FIG. 20, in the client 300, when the OK button 2205 or the display button 2206 for displaying a center satisfying safety is clicked by the input device 305 of the cloud user on the evaluation result screen 2200, the application 308 transmits information indicating the clicking of the button to the safety evaluation machine 200.

When the safety evaluation module 206b receives clicking of the OK button 2205 on the result display screen 2200 from the client 300 (step S30), the data allocation management module 206c determines whether the evaluation result of safety is OK or NG (step S31).

When the evaluation result of safety is OK (OK in step S31), the data allocation management module 206c uploads data of the corresponding file to the server 100 of the specified data center 10 (step S32), and adds (or updates) allocation information of the uploaded file (step S33), then terminates the process.

When data of a file is uploaded to the server 100 in this manner, the data becomes available in the service that is executed by the server 100. For example, when the service provided by the server 100 is a moving image distribution service on Web, and data is a moving image to be distributed, data of the uploaded moving image can be viewed by the client 300 or the like connected to the file name 220c. In addition, when uploaded data is program data, the program can be executed on the server 100.

On the other hand, when the evaluation result of safety is NG (NG in step S31), the safety evaluation information control module 206d deletes information on the corresponding file from the data attribute information 212 (export information management table 223 and acceptance criterion information table 224) (step S34), deletes information on the corresponding file from the evaluation result table 230 (step S35), then terminates the process. When the evaluation result of safety is NG, the corresponding file can be prevented from being uploaded to the data center 10 which has a problem on safety.

The following describes the data attribute registration process (step S26 in FIG. 20).

FIG. 24 is an example of a flowchart of the data attribute registration process according to the embodiment.

In the data attribute registration process, a registration file ID, a file name and upload destination DC name and file name are given as arguments, and the safety evaluation information control module 206d selects parameters needed for determining evaluation of safety on export/import control from the export/import related regulation table 225 (step S41). To carryout evaluation of safety on export/import control, evaluation of safety on export control, evaluation of safety on re-export control, and import control in the area where the DC 10 is located from the country where the cloud user belongs are necessary. In step S41, the determination parameters that the user should set to carry out those evaluations are acquired from the export/import related

Specifically, the determination parameters for evaluation of export control can be obtained by searching the export/import related regulation table 225 using the country code specifying the country where the cloud user resides (user country code: which can be grasped from the user information table 221), and the type which is “export” as search keys. Further, the determination parameters for evaluation of re-export control can be obtained by searching the export/import related regulation table 225 using the type which is “export” and extraterritorial application is “applicable.” As only the determination parameter that is used in evaluation is selected at the time of uploading a file specified by an argument to the DC 10, it is possible to adequately prevent the user from inputting the determination parameter that is not used in evaluation at the time of uploading, thus reducing complexity.

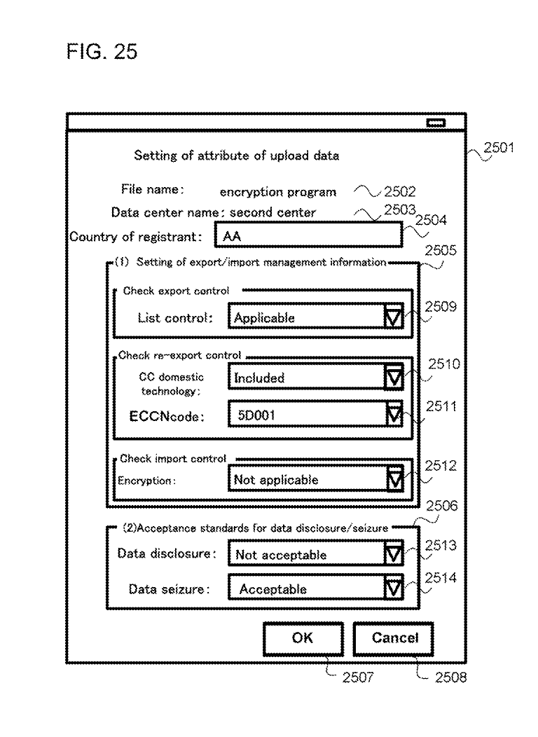

Then, the safety evaluation information control module 206d generates data for displaying the data attribute setting screen 2501, and displays the data attribute setting screen 2501 (FIG. 25) on the monitor 306 of the client 300 of the cloud user (step S42).

FIG. 25 is an example of the data attribute setting screen according to the embodiment.

A file name display area 2502 that displays the name of a file to be subject to safety evaluation, a data center name display area 2503 for displaying the name of an upload destination data center, a registrant residential country display area 2504 for displaying the code of a country where a registrant (cloud user) resides, an export/import management information setting area 2505 for setting an acceptance criterion for data disclosure/seizure risk, an OK button 2507 for settling the setting, and a cancellation button 2508 for cancelling setting are displayed on the data attribute setting screen 2501. The country of the registrant displayed in the registrant residential country display area 2504 is acquired from the user information table 221 using the registered user ID.

The export/import management information setting area 2505 is an area for setting data (evaluation code) for determining the determination parameters selected in step S41, and includes, for example, areas for setting (inputting, selecting or the like) evaluation codes of a determination parameter for confirmation of export control, a determination parameter for confirmation of re-export control, and a determination parameter for confirmation of import control. In the example of FIG. 25, the export/import management information setting area 2505 includes a list control classification setting area 2509 for setting the evaluation code of list control classification which is a determination parameter for confirmation of import control, a CC domestic technology setting area 2510 for setting an evaluation code for determining whether CC domestic technology is included for CC domestic technology (CC indicating a certain country) which is a determination parameter for confirmation of re-export control, an ECCN code setting area 2511 for setting an evaluation code indicating an ECCN code which is a determination parameter for confirmation of re-export control, and an encryption classification area 2512 for setting whether it is applicable/non-applicable to encryption which is a determination parameter for confirmation of import control.

The acceptance criterion setting area 2506 includes a data disclosure setting area 2513 for setting whether data disclosure is allowable, and a data seizure setting area 2514 for setting whether data seizure is allowable.

Referring back to FIG. 24, in the client 300, the application 308 receives an input of an evaluation code for a determination parameter made by the input device 305 of the cloud user on the data attribute setting screen 2501. When the OK button 2507 is clicked, information indicating the depression of the OK button 2507 and the evaluation code for the input determination parameter are transmitted to the safety evaluation machine 200. The cloud user may not input an evaluation code for an unknown determination parameter. As for the determination parameter that is not input, the result of evaluation on safety is not problem-free.

When the safety evaluation information control module 206d receives clicking of the OK button 2507 on the data attribute setting screen 2501 from the client 300 (step S43), the safety evaluation information control module 206d reads the input data, and stores information in the export control information table 223 and the acceptance criterion information table 224 (step S44). Specifically, the safety evaluation information control module 206d stores a set of a determination parameter name and the input evaluation code as an entry of the corresponding file in the export control information table 223, and stores the input setting on data disclosure/seizure as an entry of the corresponding file in the acceptance criterion information table 224.

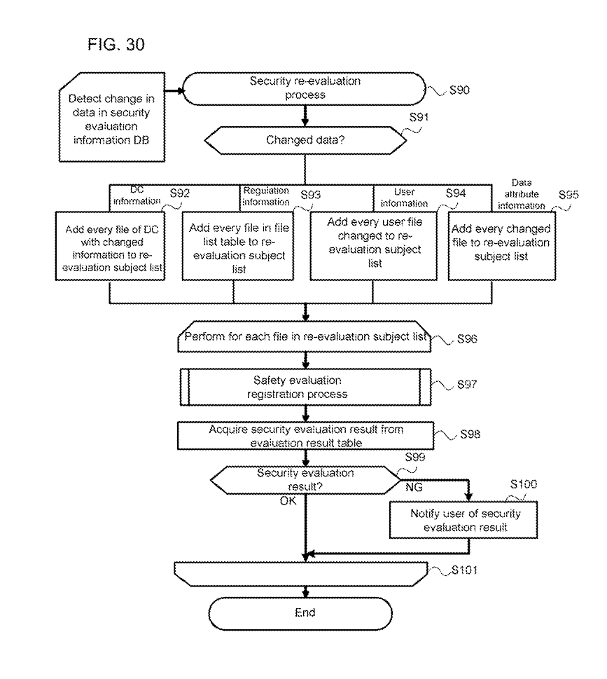

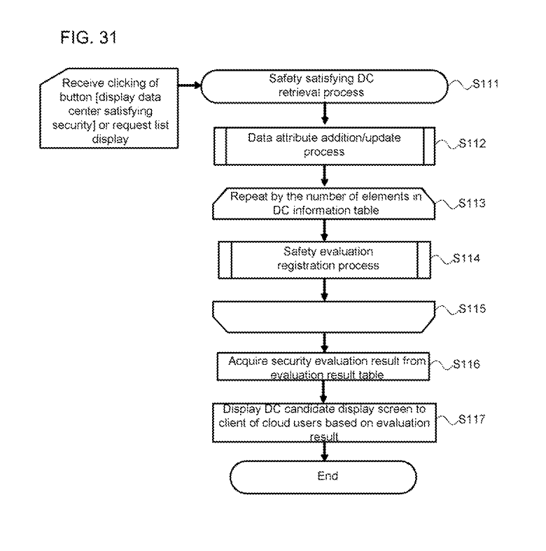

The following describes the safety evaluation registration process (step S27 in FIG. 20, step S97 of FIG. 30, step S114 in FIG. 31).

FIG. 26 is an example of a flowchart of the safety evaluation registration process according to the embodiment.

The safety evaluation registration process is executed when requested in the process upon data upload (FIG. 20), the safety re-evaluation process (FIG. 30), and the safety satisfying DC retrieval process (FIG. 31), or when requested by the client user via the client 300.

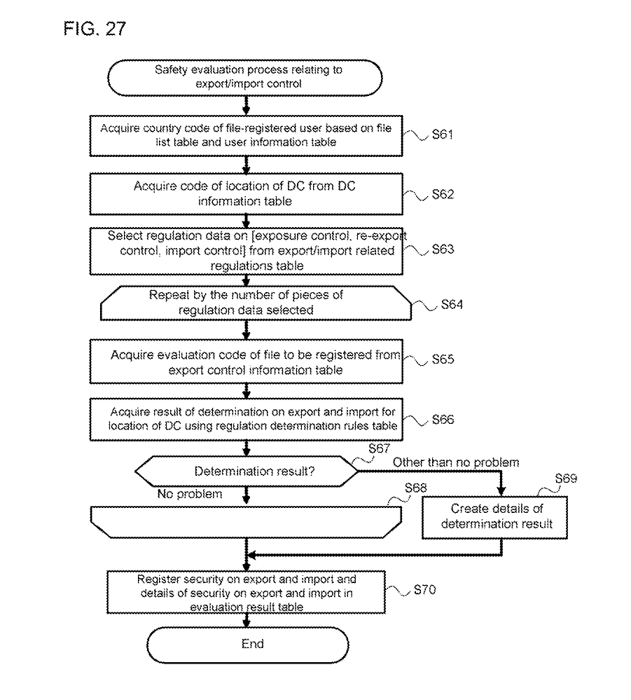

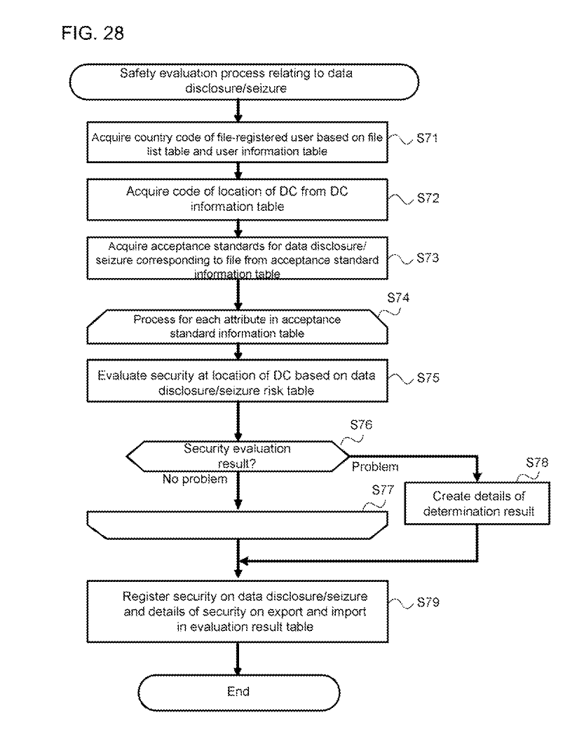

When receiving a request to start executing the safety evaluation registration process, the safety evaluation module 206b starts executing the safety evaluation registration process, executes the safety evaluation process (FIG. 27) on export/import control with the target file ID and target DC name used as arguments (step S51), and executes the safety evaluation process (FIG. 28) on data disclosure/seizure with the target file ID and target DC name used as arguments (step S52).

Next, the safety evaluation module 206b determines the evaluation of safety for the evaluation target DC 10 based on the evaluation result table 230 (step S53). Specifically, the safety evaluation module 206b determines the evaluation as OK when there is no problem in both of the evaluation result of the safety of export/import control, and the evaluation result of the safety of data disclosure/seizure, and determines the evaluation as NG when there is a problem in either one of the evaluations. Then, the safety evaluation module 206b registers the determination results in the DC safety 230c in the evaluation result table 230 (step S54), then terminates the process.

Next, the safety evaluation process related to export/import control (step S51 in FIG. 26) is described.

FIG. 27 is an example of a flowchart of the safety evaluation process on export/import control according to the embodiment.

To prevent the cloud user from making export control violations, the safety evaluation process related to export/import control carries out evaluation of safety on the export control in the countries of the cloud users, and evaluation of safety on the re-export control for the countries where the DCs 10 are located. To prevent the cloud user from making import control violations in the country where the DC 10 is located, the safety evaluation process related to export/import carries out evaluation of safety on import control.

In the safety evaluation process related to export/import, the safety evaluation module 206b acquires the user country code of the cloud user who registers the file with the target file ID of the argument based on the user information table 221 (step S61). Then, the safety evaluation module 206b acquires a location code corresponding to the target DC name of the argument (step S62).

Then, the safety evaluation module 206b selects an entry (regulation data) from the export/import related regulation table 225 (step S63). Specifically, the safety evaluation module 206b selects the regulations about export control by retrieving an entry with a country code being the country of the cloud user and the type being “export.” Further, the safety evaluation module 206b selects the regulations about re-export control by retrieving an entry with the type being “export” and the extraterritorial application being “applicable.” The safety evaluation module 206b also selects the regulations about import control by retrieving an entry with a country code being the country of the DC and the type being “import.”

Then, the safety evaluation module 206b repeatedly executes the processes of steps S64 to S68 by the number of pieces of regulation data selected.

That is, the safety evaluation module 206b acquires the evaluation code of the registration target file from the export control information table 223 (step S65), and acquires determination results for export and import to and from a country where the DC 10 is located using the evaluation code and the country where the DC 10 is located from the corresponding regulation determination rule table (226, 227) (step S66).

Then, the safety evaluation module 206b determines whether the determination result has a problem (step S67), proceeds to step S68 when the determination result has no problem, and proceeds to step S69 when the determination result has a problem.

In step S69, the safety evaluation module 206b creates the details of the determination result. For example, the safety evaluation module 206b creates the details (for example, “export control”: permission needed and regulation name being “EAR”) from the name of the regulations which have been determined as having no safety problem and the contents of the evaluation code.

When repeating the processes of steps S64 to S68 ends, or when step S69 is executed, a record including the contents corresponding to the export/import safety 230d and the export/import safety details 230e is registered (step S70), and then the process is terminated. It should be noted that when the records with the same file ID and the same DC name are registered in the evaluation result table 230, the contents of the records are updated.

Here, the safety evaluation process on export/import control is described by way of specific examples.

For example, in step S63, the export/import related regulation table 225 is set as shown in FIG. 11, the country code where the cloud user who is attempting to register a file resides is “AA,” and the record with the country code is “AA” and the type is “export”, i.e., the topmost record in the export/import related regulation table 225 in FIG. 11 is selected.

In step S65, an evaluation code “applicable” corresponding to the “list control classification” which is a determination parameter in the record that corresponds to the file ID (here, “F001”) of the registration target in the export control information table 223 in FIG. 9 and is a determination parameter in the record selected in step S63 is acquired.

Then, in step S66, a determination result (here, “permission needed”) when the location (here, “BB”) of the DC 10 to which a file is to be uploaded is set for an export place, and the evaluation code is “applicable” is obtained. Accordingly, it is determined that export permission is needed to upload a target file to the DC 10 which is attempting to upload a file. It is apparent from the export/import related regulation table 225 that the name of the regulations that need permission is the Foreign Exchange and Foreign Trade Law.

Then, the safety evaluation process related to data disclosure/seizure is described (step S52 in FIG. 26).

FIG. 28 is an example of a flowchart of the security evaluation process on data disclosure/seizure according to the embodiment.

In the safety evaluation process related to data disclosure/seizure, the safety evaluation module 206b acquires the user country code of the cloud user who registers the file with the argument target file ID based on the file list table 220 and the user information table 221 (step S71). Then, the safety evaluation module 206b acquires the location code 222b corresponding to the argument target DC name from the DC information table 222 (step S72).

Then, the safety evaluation module 206b acquires the acceptance criterion for the target file from the acceptance criterion information table 224 (step S73).

Then, the safety evaluation module 206b repeatedly executes the processes of steps S74 to S77 for each attribute of the acceptance criterion information table 224 (data disclosure and data seizure in this embodiment).

In other words, the safety evaluation module 206b evaluates safety at the location of the target DC 10 for the target attribute based on the data disclosure/seizure risk table 229 (step S75). For example, in a case where the data disclosure is “not allowable” in the acceptance criterion in formation table 224, when the value for data disclosure with respect to the country code of the location of the DC 10 in the data disclosure/seizure risk table 32 is “applicable,” it means that there is an unallowable risk, so that it is determined that “problem is present.” When “allowable” is set in the acceptance criterion information table 224, it is determined that “there is no problem” regardless of the value of the data disclosure/seizure risk table 229.

Then, the safety evaluation module 206b determines whether the determination result has a problem or has no problem (step S76). When the determination result has no problem, the safety evaluation module 206b proceeds to step S77, whereas when the determination result has a problem, the safety evaluation module 206b proceeds to step S78.

In step S78, the safety evaluation module 206b creates the details of the determination result. For example, the safety evaluation module 206b creates the contents of the risk that has been determined as having a problem with safety, and the name of the related regulations.

When repeating the processes of steps S74 to S77 ends, or when step S78 is executed, contents corresponding to the security 230f of data disclosure or the like and the details 230g of security of data disclosure or the like of the evaluation result table 230 are registered (step S79), and then the process is terminated.

Although the risk is expressed in two levels of “No” and “Yes” in the data disclosure/seizure risk table 229 in the embodiment, such is not restrictive. In consideration of the number of events of data disclosure and data seizure as well as the presence/absence of the regulations, the risk may be expressed in at least three levels. In this case, at least three levels of definitions are made even in the acceptance criterion information table 224. In this case, when the levels of the risk in the data disclosure/seizure risk table 229 is equal to or less than the levels of the acceptance criterion defined in the acceptance criterion information table 224 in step S75, it should be determined that there is no problem, whereas when the levels of the risk in the data disclosure/seizure risk table 229 exceeds the levels of the acceptance criterion defined in the acceptance criterion information table 224 in step S75, it should be determined that there is a problem.

In addition, in the safety evaluation process related to data disclosure/seizure, when there is a problem with even one attribute, it is determined that there is a problem with the entire evaluation, the determination criteria may be set by the user. For example, the setting of the determination criteria “alert is generated when both risks of data disclosure and data seizure are higher by two levels from the acceptance criterion” may be received from the user, so that the determination is made based on the determination parameter criterion.

Then, the data attribute addition/update process is described.

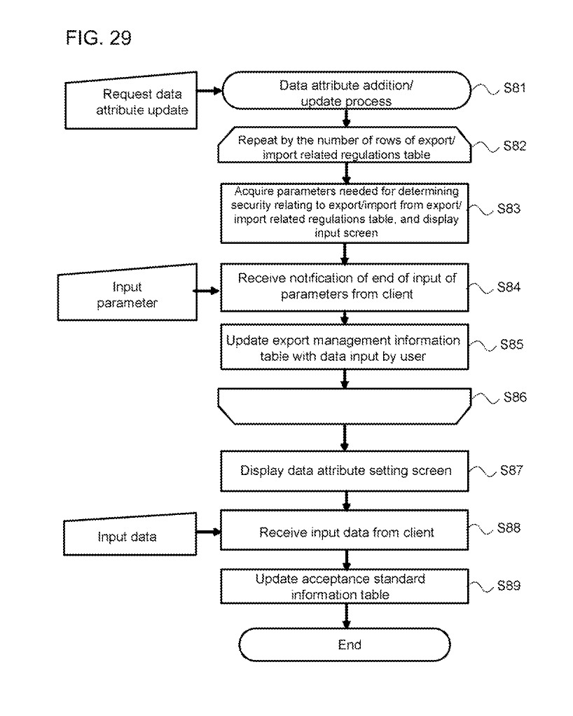

FIG. 29 illustrates an example of a flowchart of the data attribute addition/update process according to the embodiment.

The data attribute addition/update process is executed when addition or update of a data attribute becomes necessary after registering the data attributes. For example, when the data attribute addition/update process is called in the safety satisfying DC retrieval process for retrieving a DC satisfying safety for user data, and is then executed, or is executed when requested via the client 300 by the cloud user.

When the safety evaluation information control module 206d receives the data attribute update request, it starts executing the data attribute addition/update process (step S81), and repeatedly executes the processes of steps S82 to S86 by the number of entries in the export/import related regulation table 225.

The safety evaluation information control module 206d acquires a determination parameter needed for safety determination related to export/import control from the entry to be processed in the export/import related regulation table 225, generates data for displaying an input screen for inputting a value (evaluation code) for the determination parameter, and displays the input screen on the monitor 306 of the client 300 of the cloud user (step S83).

The client 300 of the cloud user receives an input of an evaluation code for the determination parameter made by the input device 305 of the cloud user on the input screen. When the input complete button is clicked, the client 300 transmits information on the depression of the input complete button (input completion notification) and an evaluation code for the input determination parameter to the safety evaluation machine 200. Here, the cloud user may not input an evaluation code for an unknown parameter. As for the determination parameter that is not input, the result of evaluation on safety is not problem-free.

When receiving clicking of the input complete button (input completion notification) from the client 300 (step S84), the safety evaluation information control module 206d reads the input evaluation code, and updates the corresponding evaluation code 223c in the export control information table 223 with the read evaluation code (step S85), and then advances to step S86.

When repeating of the processes of steps S82 to S86 by the number of entries in the export/import related regulation table 225 finishes, the safety evaluation information control module 206d generates data for displaying an acceptance criterion setting screen having the acceptance criterion setting area 2506 of the data attribute additional setting screen 2501, and displays the acceptance criterion setting screen on the monitor 306 of the client 300 of the cloud user (step S87).

Then, the safety evaluation information control module 206d receives input data for the acceptance criterion setting screen (step S88), and updates the acceptance criterion information table 224 with input data input (step S89). Accordingly, the export control information table 223 and the acceptance criterion information table 224 can be updated with new contents.

The following describes the safety re-evaluation process.

FIG. 30 is an example of a flowchart of the safety re-evaluation process according to the embodiment.

According to the computer system, when the location of the DC 10 is changed or the regulations in each country are changed to ensure proper evaluation of the safety of data, data in the safety evaluation information DB 209 needs to be changed. Further, there may be a case where the client user wants to change data attribute information in the safety evaluation information DB 209. When data in the safety evaluation information DB 209 is changed this way, the evaluation of old data is not properly evaluated at that point of time, making it necessary to newly evaluate the data.

The safety re-evaluation process is a process of detecting a situation where it is necessary to review the evaluation of the safety of the data and displaying new evaluation results.

When detecting that data in the safety evaluation information DB 209 is changed, the safety monitor manager module 206a starts the safety re-evaluation process (step S90). The safety evaluation module 206b determines which one of the DC information 214, the regulation information 213, the user information 211, and the data attribute information 212 the changed data is (step S91).

When the changed data is DC information 214 (DC information in step S91), the safety evaluation module 206b selects, from the list file table 220, the file IDs of all the files that have been managed by the DC whose information has been changed, and stores the file IDs in the re-evaluation subject list (step S92). In addition, when the changed data is the regulation information 213 (regulation information in step S91), the safety evaluation module 206b stores the file IDs in the list file table 220 in the re-evaluation subject list (step S93). When the changed data is the user information 211 (user information in step S91), the safety evaluation module 206b selects the file IDs of all the files of the changed user from the list file table 220, and stores the file IDs in the re-evaluation subject list (step S94). When the changed data is the data attribute information 212 (data attribute information in step S91), the safety evaluation module 206b stores the file ID of the file whose attribute has been changed in the re-evaluation subject list (step S95).

Then, the safety evaluation module 206b executes the processes of steps S96 to S101 for each file in the re-evaluation target list, and terminates the safety re-evaluation process completing the processing for all the files.

The safety evaluation module 206b executes the safety evaluation registration process (FIG. 26) with the file ID of the target file and the name of the DC storing the file being used as arguments (step S97). Then, the safety evaluation module 206b acquires a safety evaluation result (value of the DC safety 230c) from the safety evaluation result table 230 (step S98), and determines whether the safety evaluation result is OK or NG (step S99).

When the safety evaluation result is OK (OK in step S99), the process proceeds to step S101. When the safety evaluation result is NG (NG in step S99), the user is notified of the evaluation result, and the process proceeds to step S101. The method of notifying the user may be displaying the evaluation result screen 2200 (FIGS. 22 and 23) on the client 300 of the cloud user, or the mail address of the cloud user may be stored in advance, so that an e-mail containing the evaluation result is transmitted to the mail address. Accordingly, the cloud user can adequately grasp that evaluation of the safety of his/her own file becomes NG.

The following describes the safety sufficiency DC search process.

FIG. 31 is an example of a flowchart of safety satisfying DC search process according to the embodiment.

The safety satisfying DC retrieval process is a process for retrieving a DC satisfying safety for user data and displaying the DC. This safety satisfying DC retrieval process is executed when receiving clicking of the display button 2206 for displaying the center satisfying safety on the evaluation result screen (FIG. 22, FIG. 23), or receiving a list display request via the client 300 from the cloud user.

When receiving clicking of the display button 2206 for displaying the center satisfying safety, or receiving the list display request, the safety evaluation module 206b starts executing the safety satisfying DC retrieval process (step S111), and causes the safety evaluation information control module 206d to execute the data attribute addition/update process (FIG. 29) with the file ID of the target file being an argument (step S112)

Then, the safety evaluation module 206b repeatedly executes the processes of steps S113 to 115 for each DC registered in the DC information table 222.

With the file ID of the target file and the DC name of the target DC being used as arguments, the safety evaluation module 206b executes the safety evaluation registration process (FIG. 20) (step S114), and proceeds to step S115.

After executing the processes of S112 to S115 for each DC, the safety evaluation module 206b acquires the evaluation result from the evaluation result table 230 (step S116), generates data for displaying a DC candidate display screen 3200 (FIG. 32) based on the evaluation result, and causes the monitor 306 of the client 300 of the cloud user to display the DC candidate display screen 3200(step S117), and terminates the process.

FIG. 32 illustrates an example of the DC candidate display screen according to the embodiment.

A file name display area 3201 for displaying the name of the target file for safety evaluation, a data center name display area 3202 for displaying the name of the uploading data center, an evaluation result display area 3203 for displaying results of evaluating the safety, a detailed display area 3204 for displaying the details of the evaluation results, a data center selection area 3205 for displaying another data center whose safety evaluation result is OK, an OK button 3206 for settling the determination of a data center where data is deposited, and a cancellation button 3207 for canceling the deposit to another data center are displayed on the DC candidate display screen 3200.

The data center selection area 3205 shows radio buttons for selecting a data center where data is to be deposited. According to the embodiment, when the data allocation management module 206c of the safety evaluation machine 200 receives the depression of the OK button 3206, the data allocation management module 206c uploads data in the corresponding file to the server 100 of the selected data center 10, and adds allocation information (data center name) for the uploaded file to the file list table 220.

While the embodiment has been described above, the invention is not limited to this embodiment, and various modifications may be made without departing from the scope of the course.

For example, although the safety satisfying DC retrieval process illustrated in FIG. 31 is started in response to an operational instruction made by the client 300 of the user, the invention is not limited to this mode; for example, the safety satisfying DC retrieval process may be started automatically irrespective of the user's operational instruction when the result of safety evaluation is NG. At this time, a selection rule for determining a DC to be a reallocation destination (e.g., a rule of setting the foremost DC whose name comes first in alphabetical order among those DCs whose safeties have been approved, as a reallocation destination) may be set in advance, so that the target file is automatically reallocated to the selected DC.

Although the embodiment is illustrated to have the safety evaluation program 206 stored in a computer different from the client 300, the invention is not limited to this mode; for example, the safety evaluation program 206 may be stored in the client 300 to execute the processes. In other words, the client 300 may be used as the safety evaluation computer.

### REFERENCE SIGNS LIST

10 Data center
100 Server computer
200 Safety evaluation machine
300 Client

1. A safety evaluation method to be executed by a computer system having a client computer, a safety evaluation computer, and a server computer, the method comprising:
evaluating safety of user data which is data of the client computer and relating to storage into the server computer based on a server area ID which is an area ID of an area where the server computer is located, and displaying a result of evaluation of the safety.

2. The safety evaluation method according to claim 1,
wherein evaluation of the safety of the user data is executed further based on a client area ID which is an area ID of an area where the client computer storing the user data is located.

3. The safety evaluation method according to claim 2,
wherein evaluation of the safety of the user data is executed based on regulation information in the area corresponding to the server area ID.

4. The safety evaluation method according to claim 3, comprising:
receiving attribute information relating to evaluation of the safety of the user data; and
evaluating the safety of the user data based on the attribute information.

5. The safety evaluation method according to claim 4,
wherein the regulation information includes information relating to presence/absence of regulations on disclosure or seizure of data stored in the server computer in the area corresponding to the server area ID, and
wherein safety on disclosure or seizure of the user data is evaluated based on the regulation information.

6. The safety evaluation method according to claim 5,
wherein the safety on disclosure or seizure of the user data is evaluated based on a criterion of whether accepting disclosure or seizure of the user data of a user of the client computer.

7. The safety evaluation method according to claim 6,
wherein the regulation information includes a regulation name for the regulations for disclosure or seizure of data stored in the server computer, and
wherein, when evaluation of the safety on disclosure or seizure of the user data has a problem with safety, a name of regulations based on which it is determined that there is the problem is displayed.

8. The safety evaluation method according to claim 7,
wherein the regulation information includes information on regulations on export control of data in the area corresponding to the client area ID, and
wherein safety on export of the user data is evaluated based on the regulation information.

9. The safety evaluation method according to claim 8,
wherein, when the attribute information for the user data or the regulation information is changed, safety of the user data is evaluated again, and
wherein a result of re-evaluation is displayed.

10. The safety evaluation method according to claim 9, comprising:
detecting other server computers located in areas where there is not a problem with safety of the user data, and displaying information of the other server computers.

11. The safety evaluation method according to claim 10,
wherein the user data is reallocated in one of the other server computers.

12. A safety evaluation computer having a processor and a storage device,
wherein the storage device is configured to store a server area ID which is an area ID of an area where a server computer capable of storing data is located and information relating to evaluation of safety of data in the area in association with each other, and
wherein the processor is configured to
evaluate safety of data b based on the server area ID at a time of storing the data in the server computer, and
display a result of evaluation of the safety on a predetermined apparatus.

13. The safety evaluation computer according to claim 12,
wherein the storage device is configured to store the server area ID and regulation information relating to evaluation of safety of data in the area with the server area ID in association with each other, and
wherein the processor is configured to evaluate the safety of data based on the server area ID and the regulation information at a time of storing the data in the server computer.

14. The safety evaluation computer according to claim 13,
wherein the regulation information includes information relating to presence/absence of regulations on disclosure or seizure of data stored in the server computer in the area with the server area ID.

15. The safety evaluation computer according to claim 13,
wherein the storage device is configured to store a client area ID which is an area ID of an area where a client computer storing the data is located, and regulation information on export control of data in the area corresponding to the client area ID, and
wherein safety on export of the user data is evaluated based on the regulation information.
